(19) United States
(12) Patent Application Publication
(10) Pub. No.: US 2005/0149510 A1
(43) Pub. Date: Jul. 7, 2005

(54) Concept mining and concept discovery-semantic search tool for large digital databases

(76) Inventor: Uri Shafrir, Toronto (CA)

Correspondence Address: BERESKIN AND PARR, 40 KING STREET WEST, BOX 401, TORONTO, ON, M5H 3Y2, CA

(21) Appl. No.: 11/028,679

(22) Filed: Jan. 5, 2005

Related U.S. Application Data
(60) Provisional application No. 60/534,410, filed on Jan. 7, 2004.

(51) Int. Cl. G06F 7/00

(52) U.S. Cl. 707/3

(57) ABSTRACT

The conceptual content of a discipline may be mapped by systematically identifying hierarchical and lateral links among lexical labels of the discipline. The hierarchical links connect a super-ordinate (or “parent”) concept to its sub-ordinate (or “child”) concepts. The lateral links provide relations between the concepts. Lexical labels do not accept synonyms; however, relations do accept synonyms. Conceptual content of documents in a digital text database may be identified, and documents may be subsequently sorted and ranked by their conceptual content.

### BACKGROUND OF THE INVENTION

The invention generally relates to searches in large digital databases. In particular, embodiments of the invention relate to systematic ways to map the conceptual content of a discipline; to identify documents that encode particular conceptual content, to create textual and graphic representations of conceptual structure by hierarchical and lateral linking of concepts with their building blocks; and applications thereof.

Language is used to communicate ideas, but words and expressions are flexible in meaning and inherently ambiguous. Consequently, it is not uncommon for words to be misunderstood.

For clarity, certain words and phrases have acquired over time rigid meanings in a particular context. The article “Linguistic aspects of science” by L. Bloomfield, at pages 215-277 in O. Neurath, R. Carnap & C. Morris (Eds.) International Encyclopedia of Unified Science, vol. 1, nos. 1-5 (Chicago: University of Chicago Press, 1955), traced the development of specialized use of language to early division of labor and the development of specializations in practical occupations such as carpentry, fishing, etc. The very nature of such specialization is rooted in careful observations that eventually resulted in awareness and recognition of regularities in the environment: Some fish travel in schools; follow certain weather patterns; and are more prone to be caught when specific bait is used. Certain words, used to describe such regularities, acquire over time specific meanings that differ from their ordinary meanings in the language. These “code words” are like secret passages that lead to hidden stores of organized information: ways of conceptualizing an otherwise chaotic avalanche of undifferentiated facts. These words do not comprise a new language; rather, they are ordinary words used within a particular framework of the language to communicate special meanings: specific conceptual content in the context of the body of knowledge of a discipline, a profession, or a specialization.

The following quote from page 13 of A. Einstein & L. Infeld, The evolution of physics: From early concepts to relativity and quanta (New York: Simon and Shuster, 1938) illustrates the need for such “code words”:
“But science must create its own language, its own concepts, for its own use. Scientific concepts often begin with those used in ordinary language for the affairs of everyday life, but they develop quite differently. They are transformed and lose the ambiguity associated with them in ordinary language, gaining in rigorousness so that they may be applied to scientific thought.”

All disciplines use “secret codes” to communicate meaning; this is what scientists and other professionals mean by “shop talk”: common construction of meaning by initiates who share the discipline's secret code. It is easy to verify that such codes exist in mathematics, the natural and applied sciences, social sciences and professions such as accounting, law, architecture, etc.

The “code words” have different meanings than the literal meanings of the words. Consequently, a competent user of language who is not an expert in a particular discipline will “understand every word” of a lecture given by an expert in the particular discipline, but will not be aware of the specific meaning the expert intended to convey by the use of the “code words”.

For example, a competent user of language may assume that the sentence “Scaffolding will make the process much more efficient.” relates to renovations or repair to a building. However, for educational psychologists ‘scaffolding’ is a code word for a certain learning-facilitation strategy; it means assistance provided by a competent adult who mediates the task-at-hand to a young learner, and it follows known ideas about the socio-cultural nature of cognitive development. So, the word “scaffolding” is shared by the two very different disciplines of psychology and architecture. But these different disciplines clearly do not share the same meaning of “scaffolding”.

In contrast to traditional search engines that identify web pages containing specified keywords (e.g., Google™; Yahoo!™; etc.), a semantic search tool seeks to identify pages that share conceptual content. Limitations on the possible use of keyword searches as semantic searches stem from two characteristics of natural language, namely, polysemy (a particular word might be associated with several different meanings) and synonymy (a concept might be encoded in several different sequences of words). Therefore, keyword searches often result in large number of ‘hits’ (web pages) that are not only irrelevant to the conceptual content sought, but are also ranked by irrelevant criteria (e.g., number of links from other web pages). Current semantic search technologies include: Annotating web pages with various meta tagging schemes (e.g., Resource Description Framework (RDF) and Web Ontology Language (OWL)); and Latent Semantic Indexing (LSI) in which not only important keywords in the document are noted, but also patterns of word use are compared across documents. Annotation is a costly process, must be updated periodically, and increases significantly the volume of text in a tagged document (often by a factor of 10 or more). LSI searching requires not only to exclude ‘extraneous words’ (e.g., articles; common verbs; pronouns; etc.) from comparison for similarity of meaning between each two documents, but also to include all ‘content words’. These requirements make LSI semantic search very demanding in terms of computational resources.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a graphical illustration of the parsing of concepts into three orthogonal components in the language space, according to an embodiment of the present invention;

FIG. 2 is an illustration of the partial structure of an exemplary node in a concept parsing map, according to an embodiment of the invention;

FIG. 3 is an exemplary graphical representation of a user-interface to be presented to a person wishing to use concept parsing algorithm search tools as a search tool, according to an embodiment of the invention;

FIG. 4 is a flowchart of an exemplary method of concept discovery, according to an embodiment of the invention; and

FIG. 5 is an exemplary graphical representation of a user-interface to be presented to a person wishing to use concept parsing algorithm search tools as a search tool, according to another embodiment of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods and procedures have not been described in detail so as not to obscure the embodiments of the invention.

Lexical Labels of Concepts

A “lexical label” is a sign that signifies a regularity. As explained above, different disciplines use words as lexical labels of concepts. The use of words as lexical labels of concepts differs from the use of these same words in ordinary language in two important ways:
1 Lexical labels of concepts do not encode the literal meanings associated with their constituent words in the daily use of the language; rather, each such label encodes a connoted meaning: a meaning rooted in the regularity being considered, that differs from the literal meaning of the word(s).
2 Lexical labels of concepts do not have synonyms; rather, each label functions like a proper name of the signified concept.

As explained above, the word “scaffolding” is shared by the two very different disciplines of psychology and architecture. But these different disciplines clearly do not share the same meaning of “scaffolding”.

The statement “The transparent walls were made possible by flying buttresses.” involves the concept ‘flying buttress’. The Art & Architecture Thesaurus® Online (http://www.getty.edu/research/conducting_research/vocabularies/aat/) defines “flying buttress” as
“Exterior arched supports transmitting the thrust of a vault or roof from the upper part of a wall outward to a pier or buttress”
   “Buttress” and “scaffolding” are both synonyms of the word “support”. Yet, the term “flying scaffolding” is obviously problematic and illustrates that lexical labels of concepts do not have synonyms.

Different formats of lexical labels of concepts are possible. A lexical label may be a single sign or a sequence of signs in a mono-level sign system namely, words in natural language; for example, the words ‘strangeness’ and ‘color’ are lexical labels of concepts in physics, where they encode meanings that are very different from their literal meanings in English; ‘scaffolding’ is a lexical label of a concept in learning theory; and ‘flying buttress’ is a lexical label of a concept in architecture that is unrelated to flying. A lexical label may also be one or more words borrowed from another primary sign system (i.e., another natural language; for example ‘bulimia nervosa’); or signs borrowed from a secondary sign system (e.g., CO₂; _); or a combination of several such elements in a multilevel sign system (e.g., F# Major).

The first stage in conducting concept parsing mapping of a content area within a discipline is to identify the lexical labels of concepts; for example, the content area algebra in the discipline of mathematics contains lexical labels such as ‘linear equation’; ‘numerical constant’; ‘variable’; etc.; the content area genetics in the discipline of biology contains the lexical label ‘bi-directionality’. A simple way to begin this task is to look for lexical labels of concepts in chapter and section headings of a textbook; a more demanding task is to explicate the meanings of such lexical labels; in other words: to define the meanings encoded in the concepts thus identified.

What is a concept?

What is the secret meaning attached to a lexical label of a concept in a scientific discipline? A paragraph in a textbook may provide an approximate definition of a concept. In order to qualify as a concept statement, such paragraph should provide a comprehensive encoding of the content of the concept—the regularity under consideration. Concept statements may be found in textbooks, or may be formulated by domain experts in the process of concept parsing mapping. In addition to natural language, secondary, specialized sign systems are often used in a concept statement for extra clarity and precision; they include visual images, symbols (e.g., mathematical, physical, chemical, biological), etc.

The following quote from page 40 of R. J. Sternberg & W. M. Williams, Educational Psychology (Boston: Allyn and Bacon, 2002) is an example of a concept statement: “Cognitive development, the changes in mental skills that occur through increasing maturity and experience”.

A close examination reveals that the concept with the lexical label ‘cognitive development’ is defined by the co-occurrence of three other concepts: ‘mental skills’, ‘maturity’, and ‘experience’. Schematically, this sentence may be parsed as follows: cognitive development={[mental skills; maturity; experience], [linguistic descriptors]} where {[ . . . ], [ . . . ]} is a set that includes two sets:
1 A set of co-occurring concepts [mental skills, maturity, experience] and
2 A set of linguistic descriptors [changes, occur, increasing]

At page 5 of the article “Concepts and cognitive science”, by S. Laurence & E. Margolis in S. Laurence & E. Margolis (Eds.), Concepts: Core readings (Cambridge, Mass.: MIT Press, 1999), this is called the Containment Model of conceptual structure. The Containment Model states that a concept is defined by co-occurrence of two or more concepts; in other words, the internal generic structure of the Containment Model of concepts is determined by co-occurrence.

The following is symbolic notation of the generic structure of the Containment Model:
C′={[C_{I}], [L_{J}]} Eqn. (1)
where C′ is the lexical label of a new (super-ordinate) concept defined by the set { . . . } that contains two sets:
[C_{I}] is a set of the lexical labels of co-occurring (sub-ordinate) concepts C₁, C₂, C₃, . . . C_{N} and
[L_{J}] is a set of linguistic descriptors L₁, L₂, L₃, . . . L_{M}.

Applying this symbolic notation to the example above, the lexical label ‘cognitive development’ is denoted by C′, a super-ordinate concept defined by the co-occurrence of the sub-ordinate concepts having the lexical labels C₁=‘mental skills’, C₂=‘maturity’, C₃=‘experience’.

Once the lexical labels of the super-ordinate concept being defined and the three co-occurring sub-ordinate concepts are specified, they cannot be replaced by synonyms without changing the content of the definition. For example, ‘mental skills’ is a lexical label of a particular psychological concept and cannot be replaced by such proximal labels as ‘brain habits’; ‘spiritual competence’; etc. without losing its intended conceptual psychological meaning. On the other hand, unlike lexical labels of concepts, the linguistic descriptors L₁, L₂, L₃, . . . L_{M} are not uniquely defined and can be replaced by synonyms. For example, ‘occur’ may be replaced by ‘take place’ without altering the meaning of the concept ‘cognitive development’ in a significant way.

The following quote from the physicist Richard Feynman, found at page 148 of D. L. Goodstein & J. R. Goodstein, Feynman's lost lecture (New York: Norton, 1996), is another example of a paragraph that may be identified as a concept statement:
“I can summarize what Newton said . . . about a planet: that the changes in the velocity in equal times are directed toward the Sun, and in size they are inversely as the square of the distance. It is now our problem to demonstrate—and it is the purpose of this lecture mainly to demonstrate—that the orbit is an ellipse.”

Feynman is, of course, discussing the physical concept of ‘gravitational force’, which is often formulated as:
Two masses m₁ and m₂ attract each other with a gravitational force F that is proportional to their product and inversely proportional to the square of the distance r between them.

This concept does not fit the Containment Model described above, although one can recognize that the relationship among the lexical label of the concept being defined namely, ‘gravitational force F’, and the lexical labels of the co-occurring sub-ordinate concepts ‘masses m₁ and m₂’ and ‘distance r between them’ is clearly that of containment. However, closer examination reveals that here the situation is not only that of containment but that there exists an additional set, that of relations (e.g., ‘proportional’; ‘inversely proportional’; ‘their product’), in addition to the set of lexical labels of co-occurring sub-ordinate concepts and the set of linguistic descriptors. This additional set signifies an internal structure that is qualitatively different from the Containment Model; this may be denoted the Inference Model of conceptual structure.

The structure of the concept ‘gravitational force’ fits the Inference Model, and therefore the set { . . . } includes—in addition to the two sets of (1) the lexical labels of co-occurring sub-ordinate concepts and (2) linguistic descriptors—also an additional set that (3) specifies relations among the lexical labels of concepts:
gravitational force F {[masses m₁ and m₂; distance r between them], [linguistic descriptors], [proportional; inversely proportional; their product]}
   where {[ . . . ], [ . . . ], [ . . . ]} is a set that includes three sets:
   1 A set of lexical labels of co-occurring sub-ordinate concepts [masses m₁ and m₂; distance r between them]
   2 A set of linguistic descriptors and
   3 A set of relations [proportional; inversely proportional; their product] between the lexical labels of the co-occurring sub-ordinate concepts, as well as between these concepts and the super-ordinate concept ‘gravitational force’.

According to some embodiments of the invention, the generic structure of the Inference Model is therefore as follows:
C′={[C_{I}], [L_{J}], [R_{J}]} Eqn. (2)
where C′ is the lexical label of a new (super-ordinate) concept defined by the set { . . . } that now contains three sets:
[C_{I}] is a set of lexical labels of co-occurring (sub-ordinate) concepts C₁, C₂, C₃, . . . C_{N}
[L_{J}] is a set of linguistic descriptors L₁, L₂, L₃, . . . L_{M} and
[R_{K}] is a set of relations R₁, R₂, R₃, . . . R_{P}.

Applying this symbolic notation to the example above, the lexical label ‘graviational force F’ is denoted by C′, a super-ordinate concept defined by the co-occurrence of the sub-ordinate concepts having the lexical labels C₁=‘mass m₁’, C₂=‘mass m₂’, C₃=‘distance r between m₁ and m₂’, as well as by the set [L_{J}] of linguistic descriptors and the set [R_{K}] that specifies the relation (R₁=their product) between these two masses, the relation (R₂=proportional) between the gravitational force and these masses, and the relation (R₃=inversely proportional) between the gravitational force and the square of the distance r.

One way to think about the difference between the Containment Model and the Inference Model is that the Containment Model introduces hierarchical structure into the conceptual content of a discipline: the defined super-ordinate concept is higher in hierarchy than the defining sub-ordinate concepts, which simply co-occur in order for the defined super-ordinate concept to emerge. In contrast, the Inference Model includes situations in which the defining concepts do not merely co-occur but, in addition to co-occurrence, are also related amongst themselves and/or to the super-ordinate concept in particular ways. These relations introduce, in addition to hierarchy, a lateral dimension into the conceptual structure; this issue will be discussed in further detail below with respect to the conceptual structures of different disciplines.

Two important emergent features in the symbolic representations of concepts may be noted. Firstly, a comparison of equations (2) and (1) reveals that in situations where [R_{K}] is an empty set, the Inference Model is reduced to the Containment Model. In other words, the Containment Model is a special case of the Inference Model of the structure of concepts. Secondly, both models are positivistic and absolutist in the sense that they are (a) defined by inclusion (of concepts and relations), but not by exclusion; and (b) independent of their conceptual environment namely, independent of context. Quite obviously, these Aristotelian drawbacks limit the utility of Equation (2) in defining concepts that may contain exclusionary rules in addition to inclusionary rules of contained concepts and relations; these drawbacks also render Equation (2) mute vis-à-vis context-dependent concepts.

For example, the inadequacy of Equation (2) becomes obvious when considering the social constructions of concepts. In Sorting things out: Classification and its consequences (Cambridge, Mass.: MIT Press, 1999) by G. C. Bowker & S. L. Star, it is demonstrated that socially constructed concepts are not mere regularities, but regularities defined in the context of social conventions and usually with the aim of propagating social goals, explicit or implicit. An interesting example is the International Classification of Diseases (ICD) that was first published in the nineteenth century (now in its 10^{th} edition). The classification rules in ICD are clearly defined not only in terms of inclusion of concepts and relations, but also of exclusion; context; and still unknown sub-ordinate concepts.

According to a further embodiment of the invention, equation (2) may be generalized by specifying a particular context X₁ for a ‘conceptual environment’ included in the definition of the super-ordinate concept C′:
(C′, X₁)={[C_{I}], [L_{J}], [R_{J}]} Eqn. (3)

Equation (3) provides a general way of making concept definitions relative to the conceptual environment, in other words, to context. This point may be clarified using the following example: a marketing concept that explicitly specifies conditions under which it is not applicable (e.g., “if there exists a competitor who has more than 50% market share”; “if inflation is more than 4%”; etc.). A further example (from psychology) is as follows: “An insecurely attached child is more likely to interact freely with a friendly stranger if her mother is present in the room”; the very nature (and definition) of the psychological concept of attachment hinges on context, namely, attachment theory in the discipline of psychology, in which the presence or absence of the mother plays a critical role.

It is not a coincidence that the examples used above to illustrate the importance of context are from business and psychology. These are disciplines in which evolution—development in context, implicitly guided by environmental constraints—played a defining role in shaping their respective conceptual content. Hence, concepts in these disciplines tend to be sensitive to context.

Concept Parsing Algorithms

Equation (3) specifies the generic structure of concepts according to embodiments of the invention, and therefore may be used as a Concept Parsing Algorithm (CPA): a formula that provides guidance for identifying the ‘building blocks’ of concepts. Equation (3) may be applied recursively on each of the contained (sub-ordinate) concepts; the results of such recursive application of Equation (3) would be to substitute lower and lower level (sub-ordinate) concepts in the definition of a given super-ordinate concept.

R. Camap, in the article “Logical foundations of the unity of science” at pages 44-62 of International Encyclopedia of Unified Science, vol. I, nos. 1-5, described the consequences of linguistic parsing and substitution of concepts. According to Carnap, recursive application would result in the reduction of higher-level scientific concepts to their constituent conceptual parts, inevitably leading to sentences that contain only words and combinations of words whose meaning is shared by all competent users of the language—scientists and non-scientists alike. Such linguistic parsing and identification of constituent parts are reminiscent of Carnap's philosophy of logical positivism, in what he called ‘constitutional definition’ of concepts, as explained at page 26 of A. Naess Four modern philosophers: Carnap, Wittgenstein Heidegger, Sarte (Chicago: University of Chicago Press, 1968).

In other words, recursive application of a Concept Parsing Algorithm (CPA) such as equation (3) would result in reducing scientific concepts—‘secret codes’—to ordinary language. However, Carnap did not offer a specific algorithm that defines conceptual structure (such as equation (3) above); neither did he recognize the fact that recursive application of constitutional definitions of concepts works not only for scientific concepts, but also for concepts found in non-scientific disciplines (e.g., architecture; social science; business).

Recursive application of equation (3) to a particular super-ordinate concept may change the appearance of the concept definition without changing its meaning. As discussed in further detail below, this characteristic of equation (3) has the important potential of constructing a pseudo-inclusive set that captures the meaning of a concept by including in this set multiple representations that may—or may not—be similar in appearance to the ‘original’ representation but that, nevertheless, each provide a (different) comprehensive definition of the concept. Such a set of representations is said to be pseudo-inclusive because, while the included representations are concept statements for the same concept, one must assume that the set is extensible namely, can be further extended to include new constructions—additional representations that provide a comprehensive definition of the concept. Upon construction of additional extensions of such a pseudo-inclusive set it may, at the limit, converge to a set that is inclusive of all representations that provide a comprehensive definition of the concept.

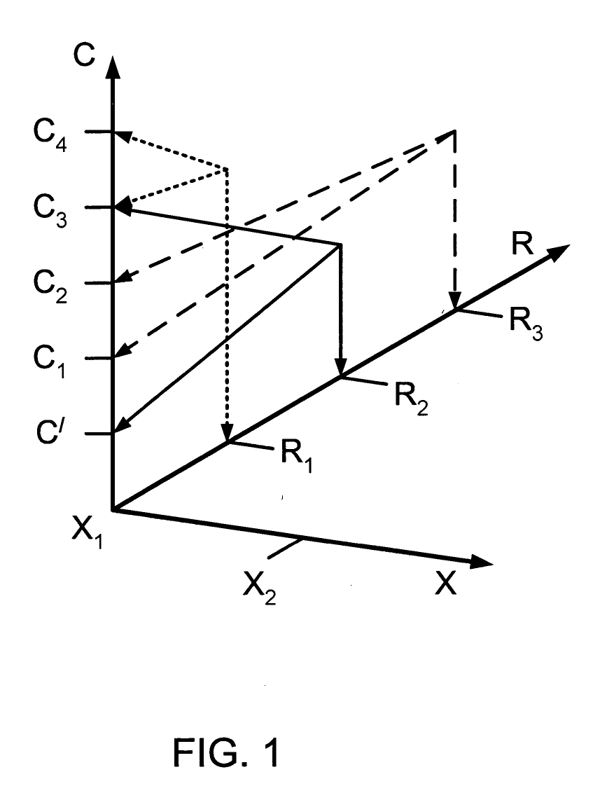

FIG. 1 is a graphical illustration of the parsing of lexical labels of concepts into three orthogonal components in the language space, according to an embodiment of the invention. The three orthogonal components, shown as a 3-dimensional coordinate system, correspond to the following: [C] for lexical labels of concepts, [R] for relations among concepts, and [X]for contexts (the conceptual environment).

In the example shown in FIG. 1, the (super-ordinate) concept C′ is defined in the context (conceptual environment) X₁ as follows:
(C′, X₁)={[C₁, C₂, C₃, C₄], [R₁, R₂, R₃]}
where in the context (conceptual environment) X₁, the super-ordinate concept with the lexical label C′ has co-occurring sub-ordinate concepts with the lexical labels C₁, C₂, C₃, C₄, R₁ (shown with dotted lines) is a relation between C₃ and C₄, and R₂ (shown with solid lines) is a relation between C′ and C₃, and R₃ (shown with a dashed line) is a relation between C₁ and C₂.

The lexical label C′ may represent a different super-ordinate concept in the context (conceptual environment) X₂, where the set of lexical labels of sub-ordinate concepts [C] and the set of relations [R] will differ from those of the lexical label C′ in the context X₁. For example, the lexical label ‘scaffolding’ has one meaning in the context of educational psychology and another meaning in the context of architecture. In another example, described in more detail below, the lexical label ‘color’ has one meaning in the context of vision and another meaning in the context of particle physics, even though in both those contexts, the lexical labels ‘red’, ‘green’ and ‘blue’ are lexical labels of co-occurring sub-ordinate concepts.

The following is a non-exhaustive list of characteristics (descriptors) of the set of co-occurring sub-ordinate concepts [C]:
The set must contain at least two concepts (N>=2; cannot be an empty set)
Each concept has a unique lexical label; no synonyms are allowed
Each concept occurs unconditionally
Co-occurring concepts are unranked
No metric is available for comparing co-occurring concepts
   The following is a non-exhaustive list of characteristics (descriptors) of the set of relations between co-occurring sub-ordinate concepts and between co-occurring sub-ordinate concepts and the super-ordinate concept [R]:
The set may be empty (P=0)
A relation does not have a unique lexical label, and may accept synonyms
A relation between two concepts is unconditional
Relations are unranked
No metric is available for comparing relations
   The following is a non-exhaustive list of characteristics (descriptors) of contexts, or conceptual environments X:
There must be at least one context for the lexical label of the super-ordinate concept
A context may have a unique lexical label, or may accept synonyms
A context includes conditions on co-occurrence and/or exclusion of particular concepts and relations among them
Contexts are unranked
No metric is available for comparing contexts
   Multiple Definitions of a Concept

Some concepts may be defined, within the same context, by two different formulations of a Concept Parsing Algorithm, say, CPA and CPA, each relying on and citing a different set of co-occurring concepts; a simple example is the definition of a circle in two different co-ordinate systems, Cartesian and polar. In other words, it is possible to write two different definitions of the concept circle using the format of equation (3) (actually, since circle is a context-free mathematical concept, equation (2) will suffice). One definition will use Cartesian coordinates, the other polar coordinates. Following Carnap's rationale for recursive reduction, one would say that these two definitions of circle are equivalent if, at the end of two chains of recursive reductions (one for Cartesian coordinates, the other for polar coordinates), one will end up with two linguistic descriptions of circle that are judged to mean the same thing by a majority of language users in a shared language community.

One way to apply Equation (3) recursively is by substituting explicit concept definitions for their lexical labels in the original sentence; this is an algorithmic procedure that is guaranteed to produce a paraphrase.

The physicist Richard Feynman was fond of testing his students' depth of comprehension by asking them to paraphrase his descriptions of physical concepts and physical situations in their own words. Feynman viewed the construction of multiple representations of mathematical and physical concepts as an important tool in the arsenal of a theoretical physicist in his quest to uncover regularities in the universe. Feynman was convinced that, although multiple representations are just reformulations and repetitions of existing knowledge of a known physical phenomenon, it is impossible to know in advance which of the representations will prove crucial in bridging the way to the construction of new knowledge. In his 1965 Nobel lecture Feynman posited multiple representations as a key aspect of scientific thinking when trying to move from the known to the unknown:
“I think the problem is not to find the best or most efficient method to proceed to a discovery, but to find any method at all. Physical reasoning does help some people to generate suggestions as to how the unknown may be related to the known. Theories of the known, which are described by different physical ideas may be equivalent in all their predictions and are hence scientifically indistinguishable. However, they are not psychologically identical when trying to move from that base into the unknown. For different views suggest different kinds of modifications which might be made . . . I, therefore, think that a good theoretical physicist might find it useful to have a wide range of physical viewpoints and mathematical expressions of the same theory . . . available to him”

In one of Feynman's lectures to freshmen physics students at Caltech in the early 1960's (published in 1963 by Addison-Wesley as Feynman's Lectures on Physics), he proved that Kepler's first law, which states that all planets move around the sun in elliptical orbits, is equivalent to the physical law which states that light rays generated at one of the foci of a reflective ellipse will converge at the other focus of the ellipse. In the terminology of some embodiments of the invention, Feynman claimed that Kepler's first law may be defined by two different Concept Parsing Algorithms, CPA and CPA

$$Kepler ' s First Law = \{ \begin{matrix}CPA = \{ [ {C}_{I} ] , [ {L}_{J} ] , [ {R}_{K} ] \} \\ \underline{CPA} = \{ [ {\underline{C}}_{I} ] , [ {\underline{L}}_{J} ] , [ {\underline{R}}_{K} ] \}\end{matrix} \qquad Eqn . ( 4 )$$

and showed the equivalence of these different definitions by leading his students through a series of steps of mathematical-physical reasoning that started at the upper definition (where the three sets {[C_{I}], [L_{J}], [R_{K}]} define an elliptical orbit) and ended at the lower definition (where the three sets {[C_{I}], [L_{J}], [R_{K}]} define the physical situation of light rays emitted at one focus, reflected by the ellipse, and converge at the other focus of the ellipse). This method of establishing the equivalence of two different expressions that encode the same underlying concept, by constructing intermediate steps and demonstrating that equivalence is maintained between each two consecutive steps, is often used in the construction of complex mathematical proofs.

It seems that the ideas of multiplicity of equivalent representations of physical laws and the nature of the linguistic reasoning paths connecting them were often on Feynman's mind. In the Messenger Lectures, delivered at Cornell University in 1964 (subsequently published in Feynman's book The character of physical law (Cambridge, Mass.: MIT Press, 1965), and in keeping with his belief that “we must always keep all the alternative ways of looking at a thing” (p. 54), Feynman demonstrated to his audience how to move from a geometric description of Newton's laws, through language, to an algebraic description of these laws; he then demonstrated that Newton's Law of Gravitation may be represented (and therefore interpreted) in 3 different ways: As action-at-a-distance; as a field; and by constructing energy integrals of alternative paths of motion of a mass (pp. 40-55); Feynman concluded: “I always find that mysterious, and I do not understand the reason why it is that the correct laws of physics seem to be expressible in such a tremendous variety of ways. They seem to be able to get through several wickets at the same time” (p. 55).

Concept Parsing Maps

The general concept parsing algorithm (CPA; equation (3)) allows the construction of a comprehensive concept parsing map of a content area or an entire discipline. Once the lexical labels of the important concepts within a particular context have been identified and individual concepts parsed into a set containing the three subsets {[C], [L], [R]} (or, in the case of multiple definitions of a concept, into several such sets), one may create a concept parsing map by consistently, graphically, connecting the links of co-occurrence and relations. Each node in such a concept parsing map designates a concept and is linked, hierarchically, both to concepts that are super-ordinate to it as well as to concepts that are subordinate to it. Each node may contain the unique lexical label of the concept, as well as one (or more) concept statements; and—for each concept statement—two or more representations that provide a (different) comprehensive definition of the concept; such multiple representations may be used as target statements in a Reusable Learning Object (RLO).

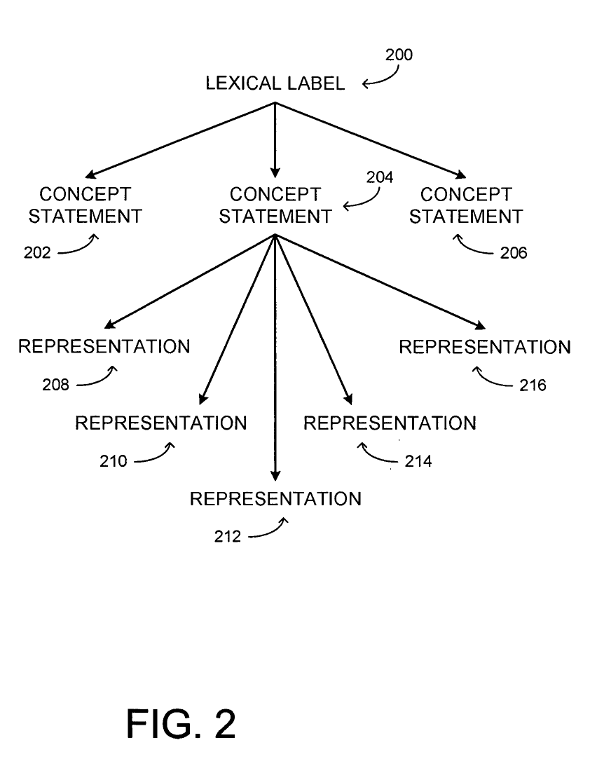

FIG. 2 is an illustration of the partial structure of an exemplary node in a concept parsing map, according to an embodiment of the invention. In this example, lexical label 200 has three concept statements 202, 204, and 206, and concept statement 204 has multiple equivalent representations 208, 210, 212, 214, and 216 that encode the regularity. Lexical label 200 is a word or words in natural language, or any sign, and does not accept synonyms. Concept statements 202, 204 and 206 are natural language and may also include secondary sign systems. Representations 208, 210, 212, 214, and 216 are any combination of sign systems.

No Synonyms of a Lexical Label of a Concept

As stated above, a lexical label of a concept does not accept synonyms. This has the effect of keeping the secret code of a discipline secret. Initiates—insiders who share the code—know that a lexical label of a concept serves a similar function to that of a proper name in identifying a particular person, object or event. In contrast, outsiders who encounter a lexical label within a discipline-specific text may assume that the label is just a ‘regular word’ and may be substituted by a synonym.

In fact, such a substitution often results in a significant alteration of the discipline-specific meaning of the concepts encoded in a text. This assertion can be demonstrated by applying semantic parsing algorithms (developed in recent years in research in computational linguistics) that compare meanings of two or more words or texts. Latent Semantic Analysis (LSA) is such a procedure and is used to demonstrate this assertion. LSA is defined by the website http://lsa.colorado/exec.html as follows:
“Latent Semantic Analysis (LSA) is a mathematical/statistical technique for extracting and representing the similarity of meaning of words and passages by analysis of large bodies of text. It uses singular value decomposition, a general form of factor analysis, to condense a very large matrix of word-by-context data into a much smaller, but still large—typically 100-500 dimensional—representation . . .
“The similarity between resulting vectors for words and contexts, as measured by the cosine of their contained angle, has been shown to closely mimic human judgments of meaning similarity and human performance based on such similarity in a variety of ways. For example, after training on about 2,000 pages of English text it scored as well as average test-takers on the synonym portion of TOEFL—the ETS Test of English as a Foreign Language . . . After training on an introductory psychology textbook it achieved a passing score on a multiple-choice exam . . . ”

The psychological concept with the lexical label ‘reinforcement’ is defined on page 132 in the introductory psychology textbook mentioned in the quote above (H. Gleitman, A. J. Fridlund & D. Reisberg, Psychology (fifth edition) (New York: W. W. Norton, 1999)) as follows:
“Reinforcement refers to strengthening a response by following it with some attractive stimulus or situation.”

It is asserted that such a lexical label, when replaced by a synonym, loses its meaning when interpreted within a discipline-specific context, but essentially retains its literal meaning when interpreted within the language at large. To test this assertion, the LSA engine (accessible through the above website) was asked to compare the meaning of ‘reinforcement’ with three different synonyms under the following two conditions: first, when interpreted within an English context; and second, when interpreted within a psychology context. Results are shown below in Table 1.

TABLE 1
LSA comparison (cosines of contained angle) of the lexical label
‘reinforcement’ with three synonyms

| | within English | within psychology |
|---|---|---|
| Synonym | context | context |
| reinforcing | 0.81 | 0.55 |
| to reinforce | 0.53 | 0.25 |
| to fortify | 0.25 | 0.09 |

These results show three clear patterns: First, the same synonyms have different alignments (cosines of contained vectors) vis-a-vis the lexical label ‘reinforcement’ when interpreted in English and in psychology; second (and this is the main point of this comparison), all three synonyms to ‘reinforcement’ retain the meaning in English much better than in psychology; finally, vectors of the two synonyms that are derivatives of the same linguistic root as the lexical label ‘reinforcement’ (i.e., “reinforcing”; “to reinforce”) are better aligned with ‘reinforcement’ than a synonym derived from a different linguistic root (i.e., “to fortify); this is the case in both English and psychology. However, in psychology even those synonyms that share a linguistic root with the lexical label ‘reinforcement’ show large discrepancies of meaning.

LSA has been used to test the assertion that discipline-specific lexical labels—unlike these same words when used in the context of everyday language—do not accept synonyms. The results above lend support to this assertion.

Conceptual Content of a Discipline

The Concept Parsing Algorithm therefore involves the following ideas:
1 Conceptual content of a discipline is encoded in a systematic mapping of descriptions of inter-related regularities in the environment—physical, biological, social, cultural, mathematical, linguistic. Conceptual content of a discipline is the sum total of the meanings encoded in all the lexical labels of the mapped descriptions of the linked regularities, plus their interactions.
2 Structure of the conceptual content of a discipline is manifested in the hierarchical and lateral linkages among concepts revealed by such systematic mapping. Hierarchical structure results from a situation of Containment, in which a super-ordinate concept is defined by co-occurrence of at least two regularities (sub-ordinate concepts). Lateral structure results from a situation of Inference, in which a super-ordinate concept is defined by co-occurrence of at least two regularities (sub-ordinate concepts) that are also linked by relationships between them and/or between them and the super-ordinate concept. Structure of the conceptual content of a discipline may be visualized through a concept parsing map, where co-occurrence and relations between nodes (concepts) are graphically revealed.
3 Each regularity is associated with a unique lexical label that functions like a proper name and does not accept synonyms; this guarantees that closely related concepts are clearly differentiated and thus unambiguously defined. The lexical label of a super-ordinate concept may be denoted a “parent” lexical label, while the lexical label of a sub-ordinate concept may be denoted a “child” lexical label.
4 Regularities associated with unique labels (concepts), as well as their interactions, may be transcoded in two or more alternative representations that share the same meaning.
   Digital Tools for Using Concept Parsing Algorithms

Several digital tools may be constructed in order to make practical use of CPA; they include: Reusable Knowledge Object (RKO); graphic representation of RKO (concept parsing map); and CPA Search Tools (CPA/SET).

A Reusable Knowledge Object (RKO) is a relational database that associates the unique lexical label of each super-ordinate concept within a particular context with the explicit definitions of the three critical sets that serve as building blocks of the concept; these are the sets of sub-ordinate concepts and relations [C_{I}]and [R_{K}], respectively.

The concept parsing map is a graphic representation of such RKO, in which individual super-ordinate concepts are nodes in a multi-dimensional lattice; the links between these nodes graphically reveal hierarchical and lateral relationships among the mapped concepts.

CPA Search Tools (CPA/SET) have three main components: (1) A search engine; (2) a specifier of a target corpus of text; and (3) a concordance and collocation tool.

The functionality of the search engine is a combination of the functionality of any generic Boolean search, plus an additional list of constraints specified by CPA. These are:
(i) an expression specifier for a unique lexical label of a super-ordinate concept; this is a fixed specifier that does not accept synonyms;
(ii) expression specifiers for the set of subordinate concepts, that do not accept synonyms;
(iii) expression specifiers for the set of relations among subordinate concepts, that accept synonyms; and
(iv) additional expression specifiers of the context, that accept synonyms.

The second component of CPA/SET is the specifier of a target corpus of text; it is a database that includes separate libraries of digital text documents, such as: URLs that share specific characteristics (by content; geography; organizational tagging; etc.); e-resources in a library catalog; e-mail stored in an organization's archive; and the like.

The third component of CPA/SET combines generic concordance and collocation functionality that enable refining an initial definition of a target super-ordinal concept through iterative proximity searches and frequency counts of co-occuring sub-ordinate concepts and their relations.

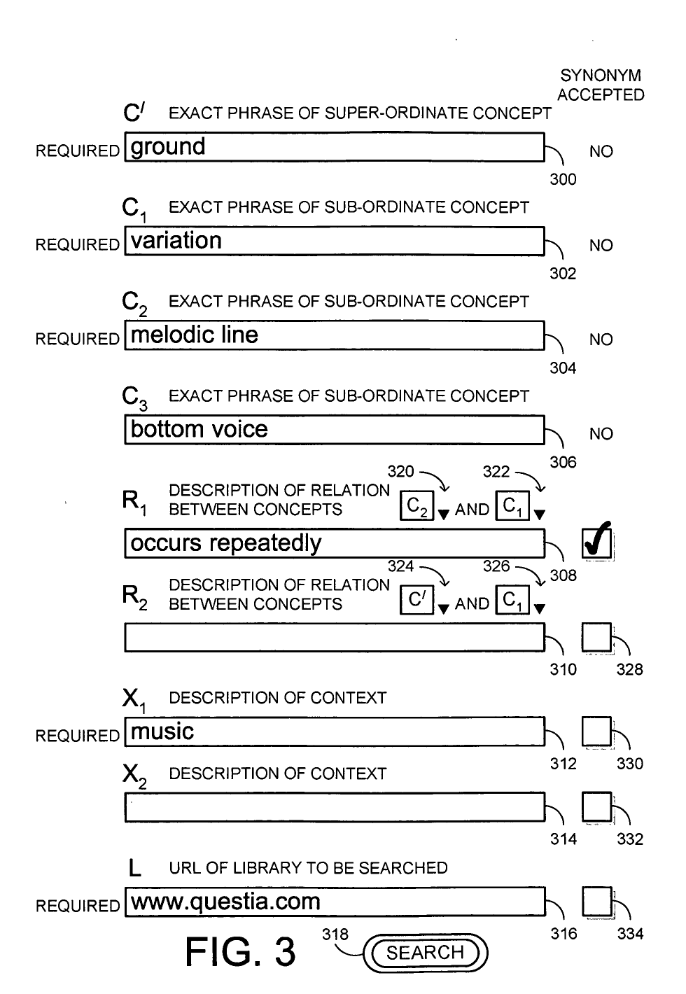

FIG. 3 is an exemplary graphical representation of a user-interface to be presented to a person wishing to use CPA/SET as a search tool. The user-interface includes fields 300, 302, 304, and 306 for the entry of lexical labels of concepts, fields 308 and 310 for the entry of descriptions of relations between concepts, fields 312 and 314 for the entry of descriptions of contexts, and a field 316 for the entry of a universal resource locator (URL) of a library to be searched. The library may be accessed via the Internet. The user-interface also includes a “search” button 318. The user-interface also includes pull down lists 320, 322, 324 and 326 of concepts. The user-interface also includes checkboxes 328, 330, 332 and 334 to indicate whether synonyms are accepted for the entries.

An exemplary application of CPA/SET involves seven consecutive steps:
1 Using CPA (equation (3)) to parse the super-ordinate concept of interest in preparation for a search
2 Specifying the list of URL libraries on which the search is to be executed (in field 316)
3 Executing the search (using “search” button 318)
4 Automatic generation of a comprehensive record keeping of expressions in all expression specifiers for the search, tagged by: searcher's name; super-ordinate concept lexical label; target corpus of text; date/time
5 Careful examination/evaluation of the result of the preceding search
6 Refining components in parsing of the super-ordinate concept definition for next search
7 Refining the list of URL libraries on which the next search is to be executed

For example, a person may wish to search for information related to the super-ordinate concept “ground” in the context of music. In a conventional search tool, searching using the word “ground” would yield many results related to the literal meaning of the word “ground” in the common use of English.
1 The person uses CPA to parse the super-ordinate concept ‘ground’. A concept statement for ‘ground’ is “A ground is a type of variation form in which a short melodic line occurs repeatedly in the bottom voice”. The sub-ordinate concepts are ‘variation’, ‘melodic line’, and ‘bottom voice’. The relationship between the sub-ordinate concepts ‘melodic line’ and ‘bottom voice’ is “occurs repeatedly”. The person enters these terms in the appropriate specifier fields of a search form, so that the search engine knows that ‘ground’ is the parent lexical label of the super-ordinate concept, ‘variation’, ‘melodic line’, and ‘bottom voice’ are the child lexical labels of the sub-ordinate concepts, and “occurs repeatedly” is the specifier of the relationship between ‘melodic line’ and ‘bottom voice’. The person also specifies the context ‘music’ in the appropriate specifier fields of the search form.
2 The person specifies the list of URL libraries on which the search is to be executed, for example, www.questia.com.
3 The person initiates execution of the search by the CPA search tool.
4 The CPA search tool automatically generates comprehensive records.
5 The person evaluates the search results.
6, 7 If the results do not satisfy his or her objectives, the person changes or refines the specifiers, and/or changes or refines the list of URL libraries.

The user-interface of FIG. 3 is appropriate in a situation where the searcher has good prior knowledge of the concept and can provide a comprehensive list of specifiers for the search. At a minimum, the searcher can provide the lexical label of the super-ordinate concept, the lexical labels of two or more sub-ordinate concepts that co-occur when the super-ordinate concept is present, and a representation of the context. This situation may be denoted “Concept Mining” (CM).

However, in other situations, the searcher may have only partial prior knowledge of the concept, and consequently can provide only a partial list of specifiers for a search. This situation may be denoted “Concept Discovery” (CD). In a Concept Discovery search, the searcher is guided through search procedures that incrementally augment the searcher's partial knowledge of a concept of interest and bring it to the level required to conduct full Concept Mining using the CPA Search Tool with all the required information, as in FIG. 3.

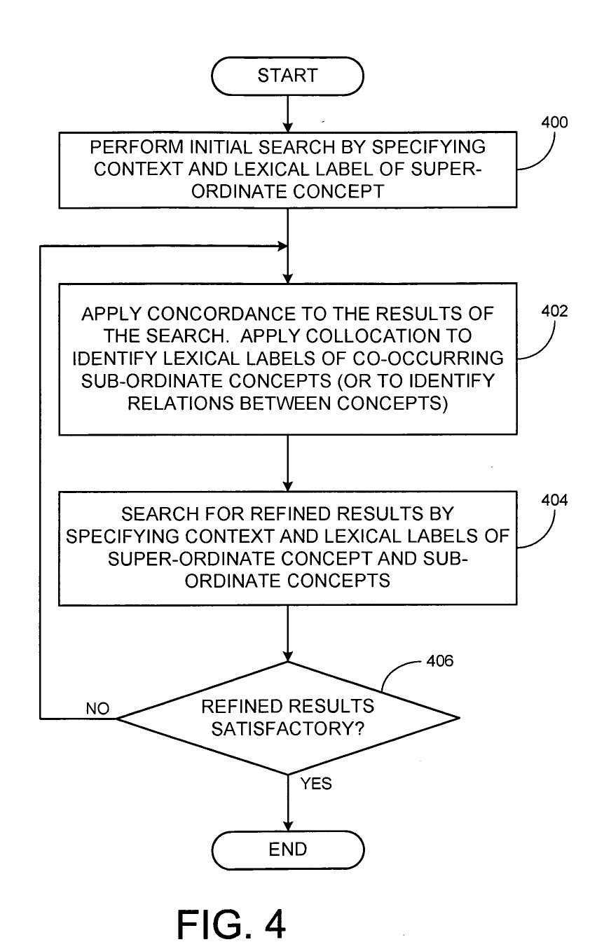

Concept Discovery (CD) is an iterative process, as shown in FIG. 4. An initial keyword search identifies all documents in the text database that contain (1) the lexical labels of a target super-ordinate concept; and (2) the context in which it emerges (400). This initial keyword search is then followed by an iterative application of two procedures—concordance and collocation—that identify lexical labels of ‘candidate’ co-occurring sub-ordinate concepts and relations between them as well as between them and the super-ordinate concept (402). The text database is then searched again, by specifying the context and the lexical labels of the super-ordinate concept and the identified co-occurring sub-ordinate concepts (404). The relations among the sub-ordinate concepts and between the sub-ordinate concepts and the super-ordinate concepts, if identified, may also be specified in the new search. If the refined results are satisfactory (406), then the method ends. If the refined results are not satisfactory (406), then the method continues from stage 402, so that the refined results are analyzed using concordance and collocation.

Context—the conceptual environment (the particular body of data together with the lexical labels of its descriptive categories, i.e., conceptual structure) in which the regularity emerges—plays an important role in determining the meaning encoded in the emergent concept. For example, a super-ordinate concept ‘color’ emerges in the particular context in biology ‘vision’; but a super-ordinate concept that carries the same lexical label, i.e., ‘color’, also emerges in a particular context in physics that carries the lexical labels ‘particle physics’ and ‘high energy physics’.

Concordance is a simple, yet powerful, tool in text analysis; its power is derived from the fact that concordance reveal patterns of usage of the target word (lexical label of the super-ordinate concept), namely, the ‘company of words’ that this target word keeps. CPA/SET use concordance to discover lexical labels of co-occurring, sub-ordinate concepts in passages that contain the lexical label of the super-ordinate concept under investigation. In each passage, displayed on a computer screen and centered on a highlighted lexical label of the super-ordinate concept, ‘candidate’ lexical labels of co-occurring concepts may be identified in the part of the passage preceding the lexical label of the super-ordinate concept under investigation, or the part of the passage following it; and collocation procedure is then used to evaluate each ‘candidate’ as co-occurring sub-ordinate concept.

The power of collocation derives from the fact that meaning tends to be communicated not through individual words in isolation, but rather through collocation of particular words within a certain span (distance between words); in English this distance is usually considered to be about 5 words, but it may extend to 10 or more words. Collocation is a proximity search procedure, applied to the results of concordance (above) in order to reveal words that appear consistently (across many passages) in close proximity to the lexical label of the emergent super-ordinate concept, through KWIC—KeyWord In Context format (see pages 44-48 of R. P. Weber, Basic Content Analysis (Quantitative Applications in the Social Sciences), (Beverly Hills, Calif.: Sage Publications, 1985)). Collocation facilitates evaluation of the role of each ‘candidate’ co-occurring concept. Once a list of co-occurring sub-ordinate concepts has been established, a similar collocation proximity search procedure is applied to ‘candidate’ relations between sub-ordinate concepts; and to relations between co-occurring concepts and the super-ordinate concept under investigation.

The output of iterative applications of concordance and collocation procedures includes frequency counts of lexical labels of co-occurring sub-ordinate concepts and their relations within each document; documents are then sorted by user-chosen, optional combinations of these various frequency counts, and rank-ordered accordingly.

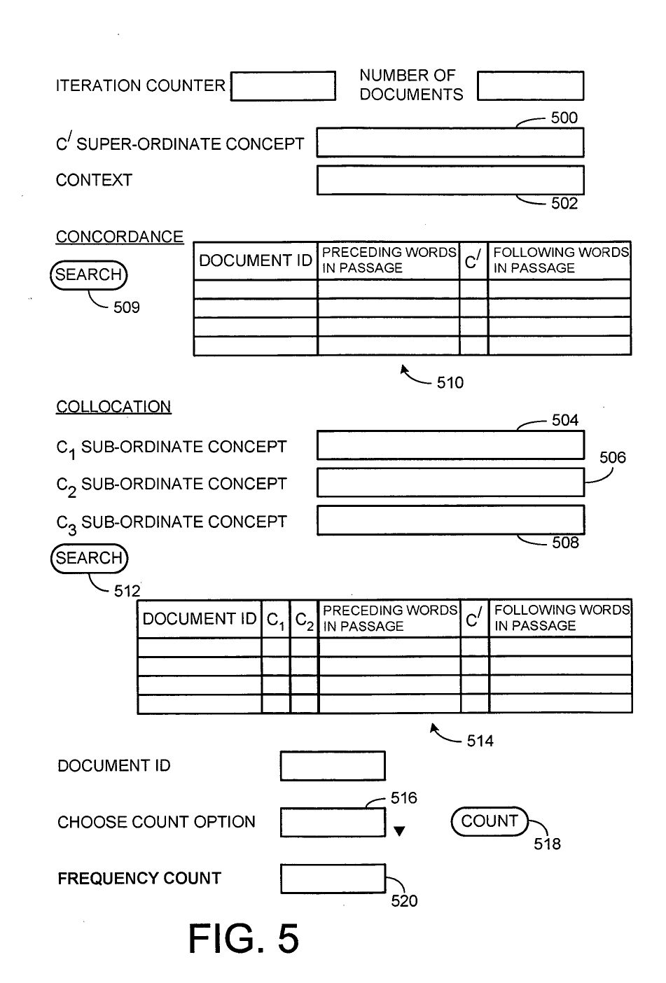

FIG. 5 is an exemplary graphical representation of a user-interface to be presented to a person wishing to use CPA/SET as a search tool for concept discovery. The user-interface includes a field 500 for the entry of the lexical label of a super-ordinate concept and a field 502 for the specification of a context. The user-interface also includes fields 504, 506 and 508 for the entry of lexical labels of sub-ordinate concepts.

A Google™ search on the keyword ‘color’ returns approximately 179,000,000 hits (web pages). By entering ‘color’ in field 500 as the lexical label of the super-ordinate concept and ‘vision’ in field 502 as the specifier of the context, a Google™ search will be performed with both keywords (i.e., ‘color’ and ‘vision’) and the number of hits is reduced to approximately 9,950,000.

By selecting a concordance search button 509, table 510 will display passages of documents in the results so that the word ‘color’ appears in the center column entitled C′. The following is a portion of an exemplary concordance of the lexical label ‘color’ in the context ‘vision’:

TABLE 2
CPA/SET concordance of lexical label of super-ordinate concept ‘color’ in the
context ‘vision’

| PRECEDING WORDS IN PASSAGE | C′ | FOLLOWING WORDS IN PASSAGE |
|---|---|---|
| The eye's high resolution | color | vision system has a much narrower angle of |
| | | coverage; light sensor cells capable of working over |
| | | a wide illumination levels and of providing quick |
| | | response to changes are called rods; high resolution |
| | | color imaging is provided by light sensor cells called |
| | | cones |
| The retina contains two types of | color | cones provide the eye's color sensitivity |
| photoreceptors, rods and cones; the rods | | |
| are more numerous and are not sensitive | | |
| to | | |
| Rods are not good for | color | vision; cones are not as sensitive to light as the rods; |
| | | signals from the cones are sent to the brain which |
| | | then translates these messages into the perception of |
| | | color |
| The receptors in your eye that are | color | are cone cells, and they are located at the back of |
| responsive to | | your eye in the layer known as the retina; rod cells |
| | | are also located in this layer |
| The human eye relies on its 6-7 million | color | vision, light adaptation, and fine detail; rods are |
| cone cells and 100-130 million rod cells | | located in the periphery of the retina and are |
| to produce normal vision; cones - blue, | | responsible for night vision, brightness perception, |
| green, and red - are located in the center | | and distinguishing shapes |
| of the retina and are responsible for | | |
| There are about 120 million rods in each | color | vision and in close precision work like reading; there |
| eye and they are more numerous towards | | are not as many cones and they are more |
| the outer edge of the retina; cone cells are | | concentrated in the center of the retina |
| used in | | |
| There are two types of photoreceptors in | color | cones are responsible for color vision |
| the eye: rods and cones; rods, which | | |
| provide vision in dim light, have no | | |
| ability to distinguish between | | |
| The eye perceives light and | color | because of cells in the retina which contain |
| | | photosensitive pigments; when a molecule of these |
| | | pigments is struck by photons, it gives up an |
| | | electron; enough of these free electrons will cause a |
| | | neuron to fire, reporting that the cell (a rod or a cone) |
| | | has received a certain amount of light |

An inspection of the concordance indicates that ‘rod’ and ‘cone’ are candidate lexical labels for co-occurring sub-ordinate concepts for ‘color’ in the context ‘vision’. By entering ‘rod’ in field 504 and ‘cone’ in field 506, and by selecting a collocation search button 512, a collocation proximity search procedure is applied to evaluate the candidates as co-occurring sub-ordinate concepts, the results of which are displayed in table 514.

TABLE 3
CPA/SET collocation of lexical labels ‘rod’ and ‘cone’ and lexical label of super-
ordinate concept ‘color’ in the context ‘vision’

| PRECEDING WORDS IN PASSAGE | C′ | FOLLOWING WORDS IN PASSAGE |
|---|---|---|
| The eye's high resolution | color | vision system has a much narrower angle of |
| | | coverage; light sensor cells capable of working over |
| | | a wide illumination levels and of providing quick |
| | | response to changes are called rods; high resolution |
| | | color imaging is provided by light sensor cells called |
| | | cones |
| The retina contains two types of | color | cones provide the eye's color sensitivity |
| photoreceptors, rods and cones; the rods | | |
| are more numerous and are not sensitive | | |
| to | | |
| Rods are not good for | color | vision; cones are not as sensitive to light as the rods; |
| | | signals from the cones are sent to the brain which |
| | | then translates these messages into the perception of |
| | | color |
| The receptors in your eye that are | color | are cone cells, and they are located at the back of |
| responsive to | | your eye in the layer known as the retina; rod cells |
| | | are also located in this layer |
| The human eye relies on its 6-7 million | color | vision, light adaptation, and fine detail; rods are |
| cone cells and 100-130 million rod cells | | located in the periphery of the retina and are |
| to produce normal vision; cones - blue, | | responsible for night vision, brightness perception, |
| green, and red - are located in the center | | and distinguishing shapes |
| of the retina and are responsible for | | |
| There are about 120 million rods in each | color | vision and in close precision work like reading; there |
| eye and they are more numerous towards | | are not as many cones and they are more |
| the outer edge of the retina; cone cells are | | concentrated in the center of the retina |
| used in | | |
| There are two types of photoreceptors in | color | cones are responsible for color vision |
| the eye: rods and cones; rods, which | | |
| provide vision in dim light, have no | | |
| ability to distinguish between | | |
| The eye perceives light and | color | because of cells in the retina which contain |
| | | photosensitive pigments; when a molecule of these |
| | | pigments is struck by photons, it gives up an |
| | | electron; enough of these free electrons will cause a |
| | | neuron to fire, reporting that the cell (a rod or a cone) |
| | | has received a certain amount of light |

A Google™ search on the keywords ‘color’, ‘vision’, ‘rod’ and ‘cone’ returns approximately 34,300 hits. By iteratively applying concordance and collocation to the results, one may identify further lexical labels of co-occurring sub-ordinate concepts, for example, ‘photoreceptor’ and ‘retina’; ‘red’, ‘green’ and ‘blue’; and ‘wavelength’.

The application of a concept discovery search, as described above, to a target database may enable the evaluation of the conceptual content of each document in the database according to CPA, while excluding documents that do not meet the clearly formulated conceptual structure embodied in CPA. Results of this type of search may be compared to simple keyword searches by defining an Information Gain function:

$$Information Gain ( IG ) = \frac{No . of hits in keyword search}{No . of hits in CPA / SET semantic search} \qquad Eqn . ( 5 )$$

Information Gain (IG) quantifies the comparison of using a semantic search of a lexical label of a super-ordinate concept in context, to a keyword search. This number is expressed most directly by reducing the number of hits, while focusing on a well-defined conceptual content. As seen in Table 4, each successive iteration increases the information gain:

TABLE 4
Comparison of CPA/SET semantic search to keyword search for super-ordinate
concept ‘color’ in the context ‘vision’

| Search type | Details | No. of hits | Information Gain |
|---|---|---|---|
| keyword | ‘color’ | 179,000,000 | — |
| CPA/SET keywords | concept ‘color’ in context ‘vision’ | 9,950,000 | 18 |
| CPA/SET concordance + collocation | concept ‘color’ in context ‘vision’ and | 34,300 | 5,218 |
| | sub-ordinate concepts ‘rod’ and ‘cone’ | | |
| CPA/SET concordance + collocation | concept ‘color’ in context ‘vision’ and | 8,770 | 20,418 |
| | sub-ordinate concepts ‘rod’, ‘cone’, | | |
| | ‘photoreceptor’ and ‘retina’ | | |
| CPA/SET concordance + collocation | concept ‘color’ in context ‘vision’ and | 4,220 | 42,217 |
| | sub-ordinate concepts ‘rod’, ‘cone’, | | |
| | ‘photoreceptor’ and ‘retina’, ‘red’, | | |
| | ‘green’ and ‘blue’ | | |
| CPA/SET concordance + collocation | concept ‘color’ in context ‘vision’ and | 958 | 186,847 |
| | sub-ordinate concepts ‘rod’, ‘cone’, | | |
| | ‘photoreceptor’ and ‘retina’, ‘red’, | | |
| | ‘green’ and ‘blue’, ‘wavelength’ | | |

Field 516 is a pull-down menu that offers various options for frequency counts, for example: count only co-occurring concepts; count only relations between co-occurring concepts; count co-occurring concepts and relations therebetween; and the like.

Once an option has been specified in field 516, counting may be activated by pressing button 518. The result of the specified frequency count then appears in field 520 for each document, and may be used to rank-order the documents by degree-of-relevance to conceptual content as specified in the search.

As mentioned above, a Google™ search on the keyword ‘color’ returns approximately 179,000,000 hits (web pages). By entering ‘color’ in field 500 as the lexical label of the super-ordinate concept and ‘particle physics’ in field 502 as the specifier of the context, a Google™ search will be performed with both keywords (i.e., ‘color’ and ‘particle physics’) and the number of hits is reduced to approximately 106,000.

By selecting a concordance search button 509, table 510 will display passages of documents in the results so that the word ‘color’ appears in the center column entitled C′. The following is a portion of an exemplary concordance of the lexical label ‘color’ in the context ‘particle physics’:

TABLE 5
CPA/SET concordance of lexical label of super-ordinate concept ‘color’ in the
context ‘particle physics’

| PRECEDING WORDS IN PASSAGE | C′ | FOLLOWING WORDS IN PASSAGE |
|---|---|---|
| quarks carry a new kind of charge known | color | unlike electric charge, which comes in one variety, |
| as | | there are three types of color charge: red, green and |
| | | blue |
| the source of | color | force between quarks and gluons in Quantum |
| | | Chromodynamics, just as electrical charge is the |
| | | source of the force between charged particles and |
| | | photons |
| quarks and gluons carry nonzero | color | charges |
| analogous to the two-valued electrical | color | charge associated with quarks & the strong force |
| charge associated with electromagnetic | | (gluons) that bind quarks together |
| force is a three-valued | | |
| there must be an additional characteristic | color | quarks come in three colors: red, green, and blue |
| of each quark so that the Pauli exclusion | | |
| principle will not be violated; this new | | |
| attribute of the quark is called | | |
| in addition to their up, down or strange | color | charge which is analogous to electrical charge but is |
| properties, quarks can be distinguished by a | | associated with the strong (rather than |
| | | electromagnetic) force; quarks are therefore labeled |
| | | red, blue and green |
| quarks of different | color | are attracted and quarks of like color are repelled by |
| | | the strong nuclear force |
| the interaction between quarks is | color | and the exchange of particles known as gluons |
| governed by their | | |

An inspection of the concordance indicates that ‘quark’, ‘gluon’ and ‘charge’ are candidate lexical labels for co-occurring sub-ordinate concepts for ‘color’ in the context ‘particle physics’. By entering ‘quark’ in field 504, ‘gluon’ in field 506, and ‘charge’ in field 508, and by selecting a collocation search button 512, a collocation proximity search procedure is applied to evaluate the candidates as co-occurring sub-ordinate concepts, the results of which are displayed in table 514.

TABLE 6
CPA/SET collocation of lexical labels ‘quark’, ‘gluon’ and ‘charge’ and lexical
label of super-ordinate concept ‘color’ in the context ‘particle physics’

| PRECEDING WORDS IN PASSAGE | C′ | FOLLOWING WORDS IN PASSAGE |
|---|---|---|
| quarks carry a new kind of charge known | color | unlike electric charge, which comes in one variety, |
| as | | there are three types of color charge: red, green and |
| | | blue |
| the source of | color | force between quarks and gluons in Quantum |
| | | Chromodynamics, just as electrical charge is the |
| | | source of the force between charged particles and |
| | | photons |
| quarks and gluons carry nonzero | color | charges |
| analogous to the two-valued electrical | color | charge associated with quarks & the strong force |
| charge associated with electromagnetic | | (gluons) that bind quarks together |
| force is a three-valued | | |
| there must be an additional characteristic | color | quarks come in three colors: red, green, and blue |
| of each quark so that the Pauli exclusion | | |
| principle will not be violated; this new | | |
| attribute of the quark is called | | |
| in addition to their up, down or strange | color | charge which is analogous to electrical charge but is |
| properties, quarks can be distinguished by a | | associated with the strong (rather than |
| | | electromagnetic) force; quarks are therefore labeled |
| | | red, blue and green |
| quarks of different | color | are attracted and quarks of like color are repelled by |
| | | the strong nuclear force |
| the interaction between quarks is | color | and the exchange of particles known as gluons |
| governed by their | | |

A Google™ search on the keywords ‘color’, ‘particle physics’, ‘quark’, ‘gluon’ and ‘charge’ returns approximately 13,100 hits. By iteratively applying concordance and collocation to the results, one may identify further lexical labels of co-occurring sub-ordinate concepts, for example, ‘red’, ‘green ’ and ‘blue’.

As seen in Table 7, each successive iteration increases the information gain:

TABLE 7
Comparison of CPA/SET semantic search to keyword search for super-ordinate
concept ‘color’ in the context ‘particle physics’

| Search type | Details | No. of hits | Information Gain |
|---|---|---|---|
| keyword | ‘color’ | 179,000,000 | — |
| CPA/SET keywords | concept ‘color’ in context ‘particle | 106,000 | 1,688 |
| | physics’ | | |
| CPA/SET concordance + collocation | concept ‘color’ in context ‘particle | 13,000 | 13,664 |
| | physics’ and sub-ordinate concepts | | |
| | ‘quark’, ‘gluon’ and ‘charge’ | | |
| CPA/SET concordance + collocation | concept ‘color’ in context ‘particle | 889 | 201,349 |
| | physics’ and sub-ordinate concepts | | |
| | ‘quark’, ‘gluon’ and ‘charge’, ‘red’, | | |
| | ‘green’ and ‘blue’ | | |

Applications of Concept Parsing Algorithms

Concept Parsing Algorithms (CPA) may be used to systematically map in as great detail—namely, degree of granularity of meaning—as is desirable, the conceptual content in any area of any discipline. Examples of specific applications are:
A) The construction of Reusable Knowledge Objects (RKO) that systematically capture and encode the conceptual content of an area within a discipline; this may result in three distinct, novel and possibly advantageous outcomes:
   (i) constructing of explicit definitions of the two critical sets that serve as building blocks of each individual super-ordinate concept in a context X; these are the sets of sub-ordinate concepts and relations [C_{I}]and [R_{K}], respectively;
   (ii) creating a graphic representation—concept parsing map—of such RKO, in which individual super-ordinate concepts are nodes in a multi-dimensional lattice; the connections between these nodes graphically reveal hierarchical and lateral relationships among the mapped concepts; and
   (iii) constructing a pseudo-inclusive set of alternative representations of a super-ordinate concept, by substituting explicit definitions of individual members of the sets [C_{I}] and [R_{K}]; this may result in clear and explicit identification of the building blocks of the super-ordinate concept—its constituent parts—in various ‘disguises’, i.e., in different representations.
B) Using CPA Search Tool (CPA/SET) through Concept Mining (CM) for the construction of Reusable Knowledge Objects (RKO), that capture and systematically encode the conceptual content—the knowledge base—of an organization; RKO can be used by an organization in two different ways:
   (i) to capture, encode, store, enhance, and retrieve its own knowledge base; this allows the organization to optimize the use of its knowledge base in planning and executing its functions and actions; and
   (ii) to search, detect, identify, capture, encode, and store the knowledge bases of other organizations that are relevant to the organization's continued well-being—both friends and foes alike.

Efficient use of CPA/SET in this manner has the potential of providing an organization with significant advantages in pursuing its goals by predicting possible futures and likely developments that may enhance—or hinder—its future well being, such as likely strategic moves by competitors; and providing a unique tool for comparative analysis of future scenarios that may result from different strategies. In addition, the application of CPA/SET enables knowledge managers to distinguish between representations that may look similar but that do not encode the same meaning, thus avoiding pursuing false leads and chasing phantoms.
C) Optimization of economic activity for financial gain through experimental deconstruction and reconstruction of concepts with enhanced value in business (established through experimental impact studies), including marketing, production and inventory control processes, etc.
D) Using CPA Search Tool (CPA/SET) in Concept Discovery (CD) mode for learning and refining knowledge. Learners may refine and enhance their partial knowledge of conceptual content by iterative application of concordance of the target super-ordinate concept in different documents and collocation (proximity search) for ‘candidate’ co-occurring sub-ordinate concepts and their relations. This may result in the following outcomes:
   (i) Concept Discovery (CD) motivates learners to search for deeper comprehension of conceptual content, by bestowing upon them the autonomy of guiding the process of meaning discovery and meaning construction.
   (ii) Each learning sequence is a journey of discovery that is minutely recorded and documented; it can be re-visited by the learner for additional gains in learning outcomes, and can be posted in the learner's e-portfolio as evidence for reflection and deep comprehension of conceptual content.
   (iii) This applies to both formal (e.g., school) and informal (e.g., workplace) learning, and may play an important role in granting recognition of prior learning by academic institutions as well as employers.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

1. A method comprising:
searching a digital text database for results that include a super-ordinate concept in a particular context by specifying:
a) a lexical label of said super-ordinate concept,
b) lexical labels of two or more sub-ordinate concepts that co-occur when said super-ordinate concept is present, and
c) said particular context,
wherein searching said database takes into account that said lexical labels do not accept synonyms.

2. The method of claim 1, wherein searching said database for results further includes specifying at least one relation between said lexical labels and specifying that said results can include synonyms of said at least one relation.

3. The method of claim 1, wherein searching said database for results further includes specifying one or more additional representations of said particular context.

4. A method comprising:
searching a digital text database for initial results that include a super-ordinate concept in a particular context by specifying a lexical label of said super-ordinate concept and by specifying said particular context;
identifying from said initial results lexical labels of two or more sub-ordinate concepts that co-occur when said super-ordinate concept is present; and
searching said database for refined results by specifying a) said lexical label of said super-ordinate concept, b) said lexical labels of said two or more sub-ordinate concepts, and c) said particular context.

5. The method of claim 4, wherein identifying said lexical labels of said two or more sub-ordinate concepts includes at least:
displaying portions of text of said initial results that precede said lexical label of said super-ordinate concept;
displaying portions of text of said initial results that follow said lexical label of said super-ordinate concept; and
counting a frequency of words in said displayed portions of text according to one or more criteria.

6. The method of claim 5, further comprising:
identifying from said refined results lexical labels of additional sub-ordinate concepts that co-occur when said super-ordinate concept is present; and
searching said database for further refined results by specifying a) said lexical label of said super-ordinate concept, b) said lexical labels of said two or more sub-ordinate concepts, c) said lexical labels of said additional sub-ordinate concepts and d) said particular context.

7. The method of claim 5, further comprising:
rank-ordering said refined results according to said frequency.

8. The method of claim 4, further comprising:
identifying from said initial results at least one relation between said lexical labels,
wherein searching said database for refined results includes specifying said at least one relation and specifying that said refined results can include synonyms of said at least one relation.

9. The method of claim 4, wherein specifying said particular context includes specifying one or more additional representations of said particular context.

10. A method comprising:
mapping conceptual content of a discipline by systematically identifying hierarchical and lateral links among lexical labels of said discipline.

11. The method of claim 10, further comprising:
graphically representing said lexical labels as nodes in a multi-dimensional lattice and graphically representing said links as connections among said nodes.

12. An article having stored thereon instructions, which when executed by a computing platform, result in:
presenting a user-interface to enable specification of search terms including at least:
a) a lexical label of said super-ordinate concept,
b) lexical labels of two or more sub-ordinate concepts that must co-occur for said super-ordinate concept to be present, and
c) said particular context; and
providing said search terms to a search engine, taking into account that said lexical labels do not accept synonyms.

13. The article of claim 12, wherein said search terms also include at least one relation between said lexical labels, and providing said search terms to said search engine takes into account that said relation does accept synonyms.

14. The article of claim 12, wherein said search terms also include one or more additional representations of said particular context.

15. An article having stored thereon instructions, which when executed by a computing platform, result in:
presenting a user-interface to enable specification of search terms including at least:
a) a lexical label of said super-ordinate concept, and
b) said particular context;
providing said search terms to a search engine, taking into account that said lexical label does not accept synonyms, to generate results;
displaying portions of text of said results that precede said lexical label of said super-ordinate concept;
displaying portions of text of said results that follow said lexical label of said super-ordinate concept; and
counting a frequency of words in said displayed portions of text according to one or more criteria.

16. The article of claim 15, wherein said user-interface further enables specification as additional search terms lexical labels of two or more sub-ordinate concepts that must co-occur for said super-ordinate concept to be present.

17. The article of claim 15, wherein said instructions, when executed by said computing platform, further result in rank-ordering said results according to said frequency.
